(19) United States
(12) Patent Application Publication
(10) Pub. No.: US 2026/0249428 A1
(43) Pub. Date: Aug. 27, 2026

(54) CENTER VISE STRUCTURE

(71) Applicant: VERTEX MACHINERY WORKS CO., LTD., TAICHUNG CITY (TW)

(72) Inventor: HAN NUNG HUANG, TAICHUNG CITY (TW)

(21) Appl. No.: 19/082,329

(22) Filed: Mar. 18, 2025

(30) Foreign Application Priority Data
Feb. 21, 2025 (TW) 114201777

(51) Int. Cl. B25B 1/10; B25B 1/02

(52) U.S. Cl. CPC B25B 1/10; B25B 1/02

(57) ABSTRACT

A center vise structure includes a base with two sides, two side slots and/or two embedding slots. Multiple zero point positioning pins are connected to a bottom of the base. A vise is placed on the base. A transmission shaft includes two external threaded parts having different thread directions, which are respectively connected with two internal threaded parts of the vise. A supporting seat is located inside the base and is used to support and position the transmission shaft. Before a mechanical arm grips the vise and installs it into a machine tool, by rotating one end of the transmission shaft, the vise grips the workpiece and automatically aligns with its machining reference center point position.

### BACKGROUND OF THE INVENTION

### Fields of the invention

The present invention relates to the technical field of mechanical processing machines, and more particularly, to a center vise structure.

### Descriptions of Related Art

The center vise (or central vise) is a tool used for holding and fixing workpieces during mechanical machining. Its key feature is that when clamping a workpiece, the two jaw blocks on both sides simultaneously move toward the center of the vise, allowing the workpiece to remain at the center zero point position. This type of center vise is suitable for clamping and machining symmetrical workpieces. Additionally, when machine tools process workpieces, coolant is typically applied to cutting tools and workpieces to protect them from overheating and damage, resulting in coolant that contains chips and metal powder after use.

However, in currently existing center vises, the two jaw blocks are designed as a single component, meaning they are manufactured as one piece with two internal threaded parts to connect with the two external threaded parts of a transmission shaft. The coolant containing chips and metal powder causes the internal transmission shaft to become clogged with these chips and powder, while also allowing them to enter the internal threaded parts of the two jaw blocks. This leads to rapid wear between the jaw blocks and the transmission shaft, requiring replacement of the entire vise, thereby shortening the service life of the center vise and increasing the machining cost of workpieces.

Furthermore, current center vises lack a fine-tuning mechanism for the center zero point position. This means that when existing center vises develop center zero point position offset errors after a period of use, they cannot be adjusted or reset to zero. Therefore, based on the aforementioned deficiencies in existing center vises, there is a genuine need for improvement.

The present invention intends to provide a center vise structure to eliminate shortcomings mentioned above.

### SUMMARY OF THE INVENTION

The present invention relates to a center vise structure, and comprises a base having a receiving slot that communicates with a top surface and two end faces of the base. A zero point slot is located at a middle of a bottom of the receiving slot. Multiple zero point positioning pins are provided on a bottom of the base. These zero point positioning pins fit into a processing table of a machine tool. A vise has a first movable jaw block and a second movable jaw block that are opposite to each other and symmetrical to the zero point slot. The first movable jaw block has a first embedding part connected to an underside thereof. A second embedding part is connected to an underside of the second movable jaw block. The first and second embedding parts are located in the receiving slot of the base. The first embedding part and the second embedding part respectively have a first internal threaded part and a second internal threaded part, wherein spiral directions of internal threads of the first internal threaded part and the second internal threaded part are different.

A transmission shaft has a first external threaded part and a second external threaded part respectively located on two sides of a middle pivot connection thereof. The first external threaded part and the second external threaded part are respectively connected with the first internal threaded part and the second internal threaded part of the first embedding part and the second embedding part of the vise. Two ends of the transmission shaft are defined as connecting ends. A supporting seat has a lower part thereof connected to the zero point slot. An upper part of the supporting seat is connected to the middle pivot connection of the transmission shaft to support and position the transmission shaft. By using a hand tool that is connected to one of the connecting ends of the transmission shaft, and rotates the transmission shaft, the vise grips or releases a workpiece.

Preferably, the zero point slot is a circular slot with two connecting through-holes defined in an inner bottom thereof. A block body extends upward from a circular part of the supporting seat. The block body has a receiving pivot hole to support the middle pivot connection of the transmission shaft. The circular part has two connecting screw holes located corresponding to the two connecting through-holes of the base so as to connect the supporting seat to the zero point slot by means of two screws.

Preferably, the middle pivot connection of the transmission shaft is a circular flange. Two annular grooves are respectively defined in both sides of the circular flange to provide installation for two O-rings. A cover body with a center through-hole is connected to the block body of the supporting seat, so as to cover the receiving pivot hole of the supporting seat and the middle pivot connection of the transmission shaft.

Preferably, the first embedding part and the second embedding part of the vise are two individual component bodies, with several screws combining the first embedding part and the second embedding part to the first movable jaw block and the second movable jaw block. A protrusion and a recess are respectively formed between the first embedding part and the first movable jaw block, and between the second embedding part and the second movable jaw block.

Preferably, a guide groove and a guide block are respectively formed between two sides of the first embedding part and the second embedding part of the vise, and two sides of the receiving slot of the base. The first external threaded part and the second external threaded part are both ACME thread.

Preferably, the first internal threaded part and the second internal threaded part of the vise are two individual component bodies, with several screws combining the first internal threaded part and the second internal threaded part respectively to a first socket hole and a second socket hole in the first embedding part and the second embedding part.

Preferably, each of the first internal threaded part and the second internal threaded part includes a triangular head combined with a threaded tube sleeve. Each triangular head has three equally divided slots through which several screws extend. The first embedding part and the second embedding part have several screw holes located corresponding to the three equally divided slots.

Preferably, two brush ring assemblies are connected to inner edges of the first internal threaded part and the second internal threaded part of the vise. The two brush ring assemblies are each composed of a brush ring and a cover body with a center through-hole.

Preferably, the base has two side slots formed to two sides thereof. Two embedding slots are formed on an inner end wall of the two side slots. A lower positioning slot, several positioning holes, and two limiting positioning pins are located in a middle of the bottom of the base.

Preferably, the two upper fixing slots are defined in a middle of the two side slots of the base. A first scale is formed on one of two sides of the base, a second scale is formed on a top surface of the vise.

The primary object of the present invention is to provide a center vise that has several zero point positioning pins or several positioning holes at the base bottom, along with the two sides of the base, the two side slots, the two embedding slots and/or the lower positioning slot, allowing the center vise to be applicable to traditional processing machines, semi-automatic and fully automatic machine tools. Therefore, the center vise has wide applicability and high practicality.

The center vise, through the two brush ring assemblies installed in the vise that contain brush rings or O-rings, blocks or removes metal chips and powder that adhere to the first external threaded part and the second external threaded part of the transmission shaft during the machining process. Therefore, the two brush ring assemblies of the center vise prevents the metal chips and powder from entering the first internal threaded part and the second internal threaded part. This reduces wear between the first internal threaded part, the second internal threaded part of the vise, the first external threaded part, and the second external threaded part of the transmission shaft, thereby extending the service life of the first internal threaded part, the second internal threaded part, and the transmission shaft, while maintaining the machining precision of the workpiece.

Similarly, the two O-rings of the transmission shaft, combined with the cover body, also function to block metal chips and powder from entering the gap between the middle pivot connection of the transmission shaft and the receiving pivot hole of the supporting seat. In addition to reducing wear, this extends the service life of the supporting seat and the transmission shaft, and maintains the smoothness of the transmission shaft's rotational transmission.

The first internal threaded part and the second internal threaded part of the center vise both adopt a separate design, meaning that when the service life of the first internal threaded part or the second internal threaded part ends, only the components of the first internal threaded part or the second internal threaded part need to be replaced, thereby avoiding the replacement of the entire vise and reducing the operating cost of this utility model vise.

Additionally, when the center vise develops an offset error in the center zero point (i.e., the machining reference center point) position, because both the first internal threaded part and the second internal threaded part are equipped with triangular heads, the triangular heads can be rotated and adjusted in coordination with the first scale on the side of the base, allowing for the adjustment and zeroing of the center zero point position where the center vise grips the workpiece. This avoids machining errors in the workpiece caused by errors in the center zero point position, thereby improving the machining precision of the workpiece.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the center vise structure of the present invention;

FIG. 2 is an exploded three-dimensional view of the center vise structure of the present invention;

FIG. 3 is a side view of the center vise structure of the present invention;

FIG. 4 is another side view of the center vise structure of the present invention;

FIG. 5 is a top view of the center vise structure of the present invention;

FIG. 6 is a longitudinal sectional view of the center vise structure of the present invention;

FIG. 7 is a longitudinal sectional view and operation schematic diagram of the center vise structure of the present invention;

FIG. 8 is a bottom view of the center vise structure of the present invention;

FIG. 9 is a schematic diagram of the center vise structure of the present invention implemented on a processing table inside a machine tool, and

FIG. 10 is a schematic diagram of the use of the center vise structure of the present invention and the center zero point offset error pattern.

### DETAILED DESCRIPTION OF THE PREFERRED EMBODIMENT

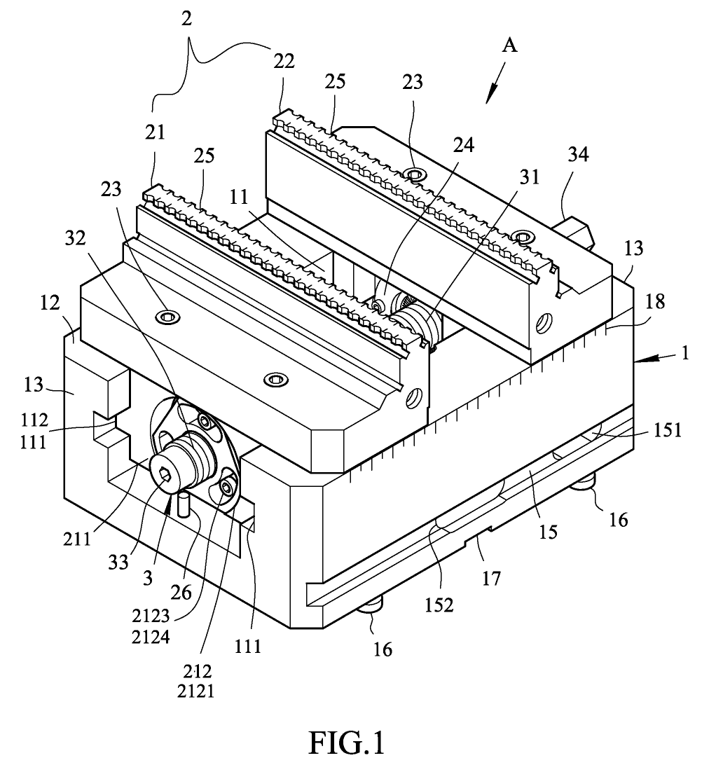

The present invention relates to a center vise structure, as shown in FIGS. 1, 9, and 10, which provides workpiece 5 clamping for traditional processing machines, semi-automatic, fully automatic and other machine tools. The center vise structure “A” includes a base 1, a vise 2, a transmission shaft 3, and a supporting seat 4.

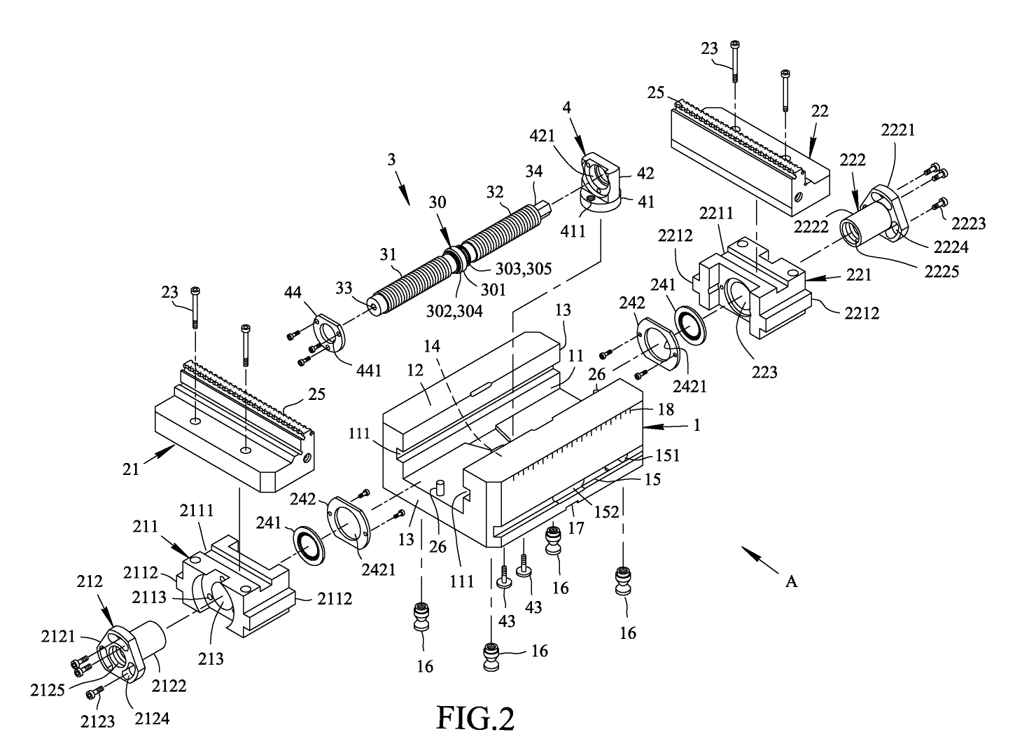

The base 1, as shown in FIGS. 2, 6, and 8, has a receiving slot 11 that communicates with the top surface 12 and both end faces 13 of the base 1, and has a zero point slot 14 in the middle of the bottom of the receiving slot 11. The so-called zero point refers to the machining reference center point of the workpiece 5, that is, the center point 141 of the zero point slot 14 is the machining reference center point (commonly called the zero point), wherein the zero point slot 14 is designed as a circular slot with two connecting through-holes 142 inside. Additionally, on the two sides of the base 1, there are two side slots 15 and two embedding slots 151 located on an inner end wall of the these two side slots 15, and two upper fixing slots 152 are set in the middle of these two side slots 15. Furthermore, several positioning holes 19 are set at the bottom of the base 1, wherein the side slot 15 works with fixtures, and the several positioning holes 19 work with an equal number of positioning pillars, which can fix the vise on the processing table of traditional processing machines. Additionally, several zero point positioning pins 16 and a lower positioning slot 17 are set at the bottom of the base 1, wherein the several zero point positioning pins 16, working with the two embedding slots 151, provide for a mechanical arm to grab the vise and fix it by inserting these several zero point positioning pins 16 into several positioning holes 61 set on the processing table 6 inside more advanced machine tools. This facilitates the clamping and fixing of the workpiece 5 and aligning it with the zero point for processing.

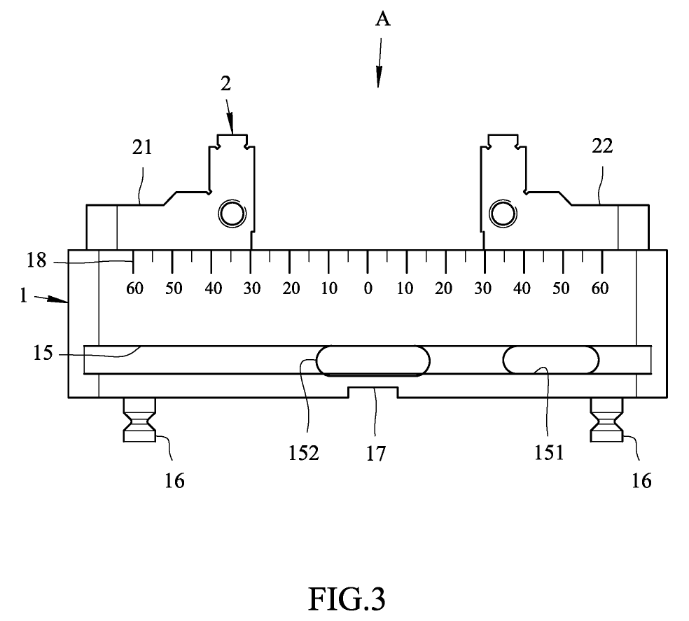

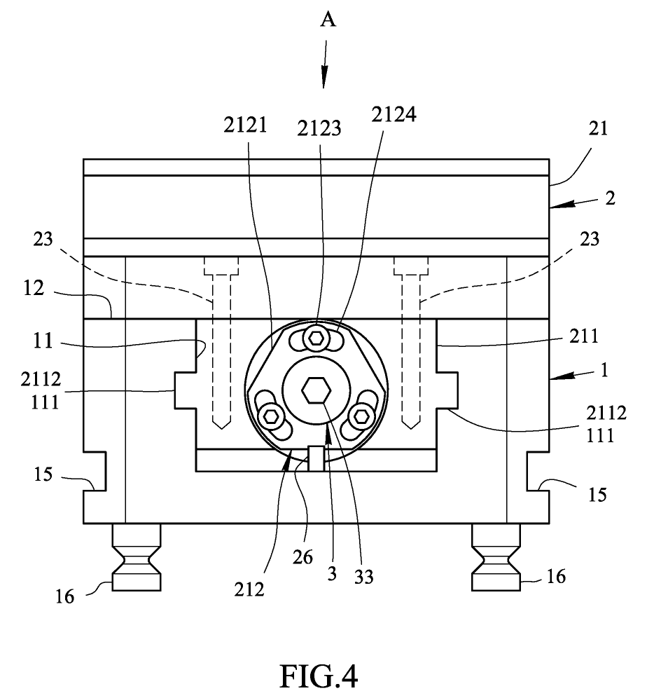

As shown in FIGS. 2 to 4 and FIG. 6, the vise 2 has a first movable jaw block 21 and a second movable jaw block 22 that are opposite to each other and symmetrical to the center point 141 of the zero point slot 14, and places a first embedding part 211 and a second embedding part 221 located beneath the first movable jaw block 21 and the second movable jaw block 22 in the receiving slot 11 of the base 1. Additionally, between the two sides of the first embedding part 211 and the second embedding part 221 of the vise 2 and the two sides of the receiving slot 11 of the base 1, there are respectively two guide grooves 111, a guide block 2112, and a guide block 2212. The first embedding part 211 and the second embedding part 221 are respectively provided with a first internal threaded part 212 and a second internal threaded part 222, and the spiral directions of an internal thread 2125 and an internal thread 2225 set in the first internal threaded part 212 and the second internal threaded part 222 are set to be different.

Furthermore, the first embedding part 211 and the second embedding part 221 are both designed as separate component bodies, with several screws 23 combining the first embedding part 211 and the second embedding part 221 to the first movable jaw block 21 and the second movable jaw block 22. A protrusion 210 and a recess 2111 are respectively set between the first embedding part 211 and the first movable jaw block 21, and a protrusion 220 and a recess 2211 are respectively set between the second embedding part 221 and the second movable jaw block 22. Moreover, the first internal threaded part 212 and the second internal threaded part 222 of the vise 2 are both designed as separate component bodies, with several screws passing through to combine the first internal threaded part 212 and the second internal threaded part 222 respectively to a first socket hole 213 and a second socket hole 223 set in the first embedding part 211 and the second embedding part 221.

Furthermore, the first internal threaded part 212 and the second internal threaded part 222 are designed both as a triangular head 2121, 2221 respectively combined with a threaded tube sleeve 2122 and a threaded tube sleeve 2222. The two triangular heads 2121 and 2221 respectively have three equally divided slots 2124, 2224, while the first embedding part 211 and the second embedding part 221 have several screw holes 2113, 2213 corresponding to the three equally divided slots 2124 and the three equally divided slots 2224. This arrangement allows several screws 2123 and several screws 2223 to extend through the three equally divided slots 2124 and the three equally divided slots 2224 and fasten to the several screw holes 2113 and the several screw holes 2213. Additionally, a brush ring assembly 24 is installed on each of the inner edges of the first internal threaded part 212 and the second internal threaded part 222. Each brush ring assembly 24 is composed of a brush ring 241 (or an O-ring made of rubber or plastic material can replace the brush ring 241) and a cover body 242 with a center through-hole 2421.

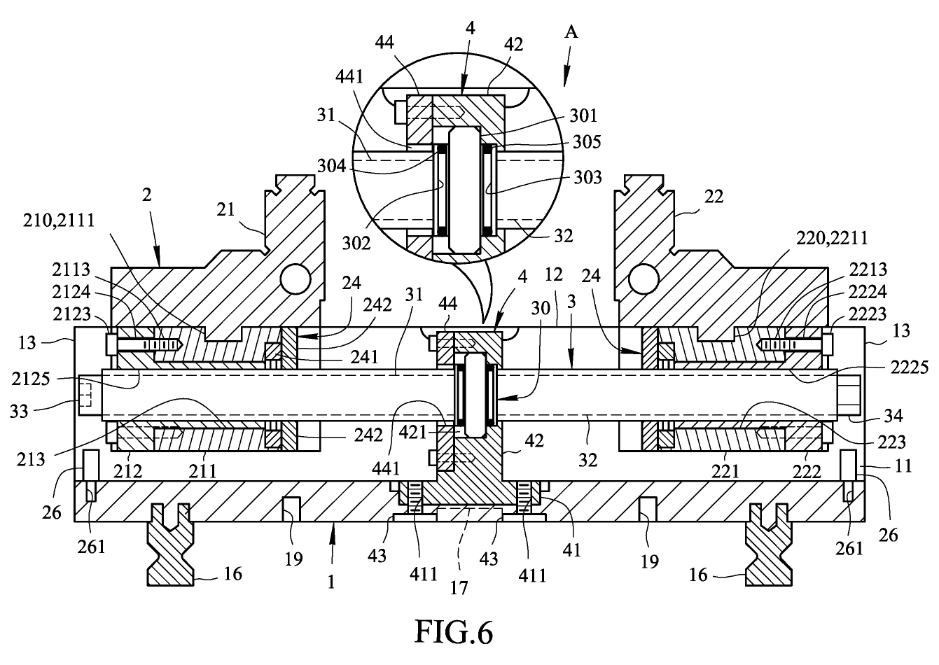

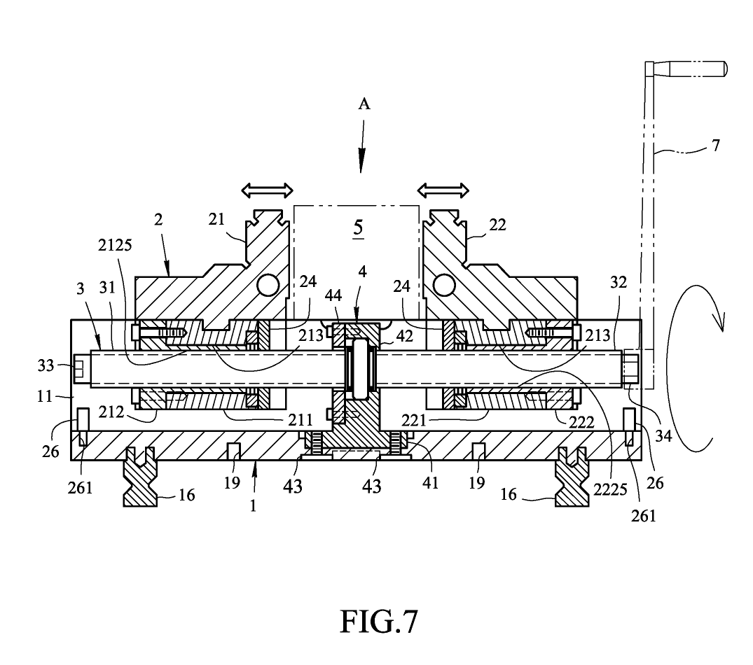

Additionally, two limiting positioning pins 26 are respectively set at both ends of the receiving slot 11 of the base 1, as shown in FIGS. 6 and 7, wherein these two limiting positioning pins 26 are locked into corresponding screw holes 261 to limit excessive opening between the first movable jaw block 21 and the second movable jaw block 22 of the vise 2 resulting in insufficient grip. That is, this limits the maximum opening distance between the first embedding part 211 and the second embedding part 221, to prevent excessive opening of the jaws of the vise of the present invention.

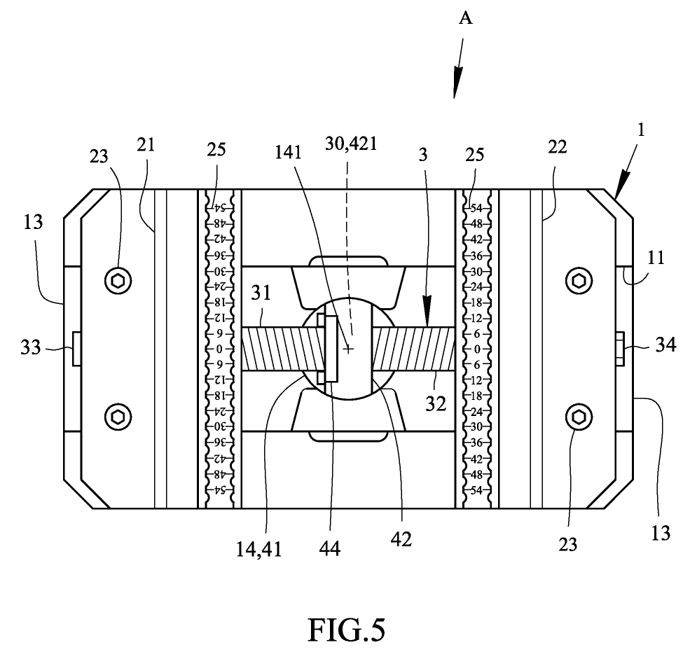

As shown in FIGS. 2, 5, and 6, the transmission shaft 3 has a first external threaded part 31 and a second external threaded part 32 respectively set on both sides of a middle pivot connection 30. The first external threaded part 31 and second external threaded part 32 are respectively connected with the first internal threaded part 212 and the second internal threaded part 222 of the first embedding part 211 and the second embedding part 221 of the vise 2. Additionally, the first external threaded part 31 and the second external threaded part 32 are both designed as ACME thread, to improve the situation where the previously used Whitworth screw thread would break, and to enhance the stability and precision of the transmission of the vise. The middle pivot connection 30 is designed as a circular flange 301, and two annular grooves 302 and 303 are respectively set on both sides of the circular flange 301 to provide installation for two O-rings 304 and 305. Furthermore, the two ends of the transmission shaft 3 are respectively formed as two connecting ends 33 and 34. In this embodiment, the connecting end 33 is an internal hexagonal slot, while the other connecting end 34 is designed as a hexagonal head.

As shown in FIGS. 2, 5, and 6, the supporting seat 4 has its lower part connected to the zero point slot 14, and its upper part connected to the middle pivot connection 30 of the transmission shaft 3, so as to support and position the transmission shaft 3. The supporting seat 4 is composed of a circular part 41 extending upward to a block body 42, and the circular part 41 is designed in a circular shape to give it a degree of freedom for deflection. Additionally, the block body 42 has a receiving pivot hole 421 to support the middle pivot connection 30 of the transmission shaft 3. Furthermore, the circular part 41 has two connecting screw holes 411 located corresponding to the two connecting through-holes 142 of the zero point slot 14 of the base 1, to facilitate combining the supporting seat 4 to the zero point slot 14 of the base 1 by means of two screws 43. A cover body 44 with a center through-hole 441 is additionally installed on the block body 42, to cover the receiving pivot hole 421 and the middle pivot connection 30 of the transmission shaft 3.

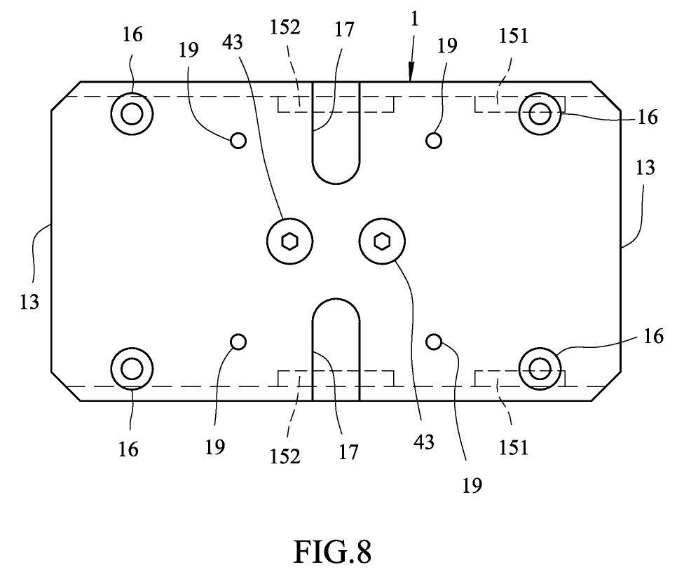

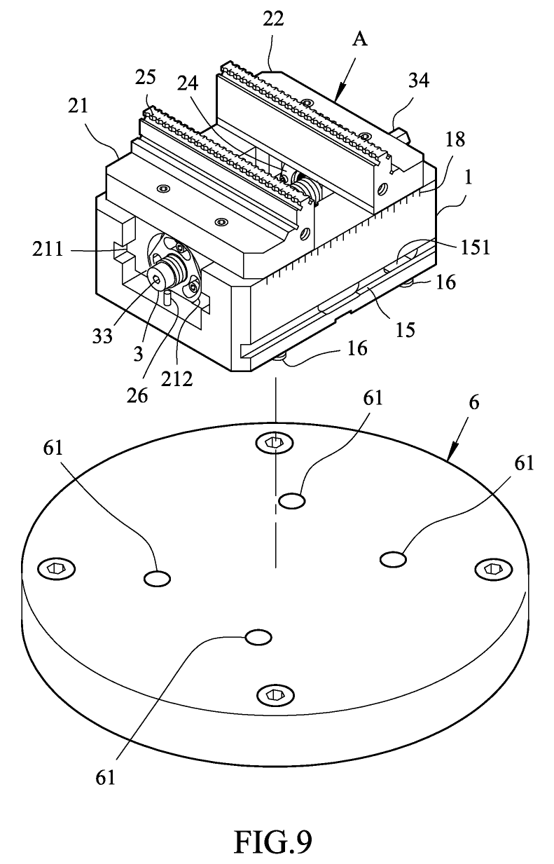

The present invention provides a better solution for a center vise structure, as shown in FIGS. 8 and 9, with the several zero point positioning pins 16, the positioning holes 19, the two side slots 15, the two embedding slots 151 and/or the lower positioning slot 17 set at the bottom of the base 1, so that the center vise of the present invention is applicable to traditional processing machines, semi-automatic and fully automatic machine tools. In other words, the center vise has wide applicability and high practicality.

When using the center vise structure “A” of the present invention, as shown in FIGS. 1 and 7, the vise 2 can be opened in advance, then using the second scale 25 on the top surface of the vise 2 to center the workpiece 5 and place it between the first movable jaw block 21 and the second movable jaw block 22 of the vise 2. Then, a hand tool 7 is connected to one of the two connecting ends 33, 34 of the transmission shaft 3, and the transmission shaft 3 is rotated by operating the hand tool 7. Because the first external threaded part 31 and the second external threaded part 32 of the transmission shaft 3 have different external thread directions, when rotating the transmission shaft 3 clockwise or counterclockwise, it can simultaneously drive the displacement of the internal thread 2125 and internal thread 2225 set in the first movable jaw block 21 and the second movable jaw block 22, to drive the first movable jaw block 21 and the second movable jaw block 22 to move closer to or away from each other. This makes the first movable jaw block 21 and the second movable jaw block 22 approach or move away from the center zero point of the workpiece 5 to grip or release the workpiece 5.

Please refer again to FIGS. 2, 6, and 7, in order to extend the service life of the first internal threaded part 212, the second internal threaded part 222, and the transmission shaft 3, as well as maintain the machining precision of the workpiece 5, the center vise of the present invention the two brush ring assemblies 24 of the vise 2 to block or remove metal chips and powder that adhere to the first external threaded part 31 and the second external threaded part 32 of the transmission shaft 3 during the machining process, preventing them from entering the first internal threaded part 212 and the second internal threaded part 222. This can reduce wear between the first internal threaded part 212, the second internal threaded part 222 of the vise 2, the first external threaded part 31, and the second external threaded part 32 of the transmission shaft 3. Therefore, the service life of the first internal threaded part 212, the second internal threaded part 222, and the transmission shaft 3 is extended, while the machining precision of the workpiece 5 is maintained. Similarly, the O-ring 304 and the O-ring 305 of the transmission shaft 3, combined with the cover body 242 of the supporting seat 4, also function to block metal chips and powder from entering the gap between the middle pivot connection 30 of the transmission shaft 3 and the receiving pivot hole 421 of the supporting seat 4, so as to reduce their wear, extend the service life of the supporting seat and the transmission shaft 3, and maintain the smoothness of operation of the transmission shaft 3.

At the same time, in order to reduce the operating cost of the center vise of the present invention, the first internal threaded part 212 and the second internal threaded part 222 both adopt a separate design, meaning that when the service life of the first internal threaded part 212 or the second internal threaded part 222 ends, only the components of the first internal threaded part 212 or the second internal threaded part 222 need to be replaced.

Additionally, when the center vise of the present invention develops a position error in the center zero point (i.e., the machining reference center point) after a period of use. Please refer to FIGS. 6, 7, and 10, because the first internal threaded part 212 and the second internal threaded part 222 are both equipped with the triangular head 2121 and its three equally divided slots 2124, and the triangular head 2221 and its three equally divided slots 2224, so that after loosening the several screws 2123 and the several screws 2223, the triangular head 2121 and the three equally divided slots 2124 can be rotated and adjusted relative to the first embedding part 211, as well as the triangular head 2221 and the three equally divided slots 2224 relative to the second embedding part 221. During the aforementioned zero point position adjustment process, the screws 43 of the circular part 41 of the supporting seat 4 can also be loosened, utilizing the degree of freedom provided by the circular shape of the circular part 41, which will be more beneficial for the operation of adjusting the zero point position.

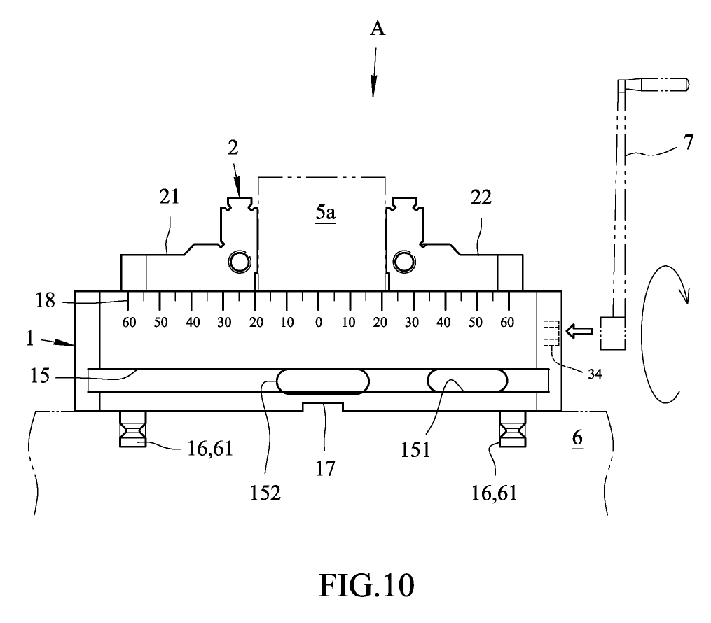

Additionally, in coordination with the first scale 18 on the side of the base 1, the center zero point position where the vise 2 grips the workpiece 5 can be adjusted, to avoid machining errors in the workpiece 5 caused by errors in the center zero point position, thereby improving the machining precision of the workpiece 5. For example, with the first movable jaw block 21 and the second movable jaw block 22 of the center vise of the present invention gripping a calibration standard 5a with a standard width of 40mm, as shown in FIG. 10. After the supporting seat 4 connected to the transmission shaft 3 has been zeroed and fixed, the center zero point position of the calibration standard 5a is biased toward the right side. Therefore, after loosening the screws 2123 and screws 2223, and then rotating and adjusting the triangular head 2121 and its three equally divided slots 2124, the triangular head 2221 and its three equally divided slots 2224, each of the triangular head 2121 and triangular head 2221 with their extended threaded tube sleeves 2122 and threaded tube sleeve 2222 can separately or simultaneously create threaded displacement on the transmission shaft 3 through the internal thread 2125 and internal thread 2225 set inside their tube bodies. This allows for fine adjustment of the first embedding part 211 and the second embedding part 221 extended on the first socket hole 213 and the second socket hole 223, thereby driving the displacement of the first movable jaw block 21 and the second movable jaw block 22 combined with each embedding part. In coordination with the first scale 18 on the side of the base 1, the center zero point position where the vise 2 grips the calibration standard 5a can be adjusted to move toward the left side, thus achieving the zeroing adjustment of the center zero point position of the center vise. After this, the screws 2123 and screws 2223 are tightened to secure the adjusted positions of the triangular head 2121 and the triangular head 2221.

Therefore, when assembling or initially using the vise 2 to place the workpiece 5 for the first time, calibration (zeroing positioning) can always be performed to enable the first movable jaw block 21 and the second movable jaw block 22 to reach the center point zero point or be zeroed. The practical application of center zero point adjustment using the supporting seat 4 located at the center of the screw rod of the transmission shaft 3, and the triangular heads 2121 and 2221 located on both sides is necessary because the machining precision of current domestic processing machines cannot meet the requirements of one-piece vise products. Therefore, the center vise of the present invention adopts a design where the transmission shaft 3 has in its middle section the supporting seat 4 with the circular part 41 located below, and on both sides of the vise are the triangular heads 2121 and 2221 equipped with the three equally divided slots 2124 and 2224, as well as the threaded tube sleeves 2122 and 2222 with internal threads. These components work together on the transmission shaft 3 to adjust the displacement of the first movable jaw block 21 and the second movable jaw block 22 from left to right, thereby enabling adjustment and control of the center zero point position. This facilitates effective zero point correction in advance when clamping workpieces for processing or calibration, and during the actual machining process.

While we have shown and described the embodiment in accordance with the present invention, it should be clear to those skilled in the art that further embodiments may be made without departing from the scope of the present invention.

What is claimed is:

1. A center vise structure, comprising:
a base (1) having a receiving slot (11) that communicates with a top surface (12) and two end faces (13) of the base (1), a zero point slot (14) located at a middle of a bottom of the receiving slot (11), several zero point positioning pins (16) provided on a bottom of the base (1), the zero point positioning pins (16) adapted to be fit into a processing table of a machine tool;
a vise (2) having a first movable jaw block (21) and a second movable jaw block (22) that are opposite to each other and symmetrical to the zero point slot (14), the first movable jaw block (21) having a first embedding part (211) connected to an underside thereof, a second embedding part (221) connected to an underside of the second movable jaw block (22), the first and second embedding parts (211, 221) located in the receiving slot (11) of the base (1), the first embedding part (211) and the second embedding part (221) respectively having a first internal threaded part (212) and a second internal threaded part (222), spiral directions of internal threads of the first internal threaded part (212) and the second internal threaded part (222) being different;
a transmission shaft (3) having a first external threaded part (31) and a second external threaded part (32) respectively located on two sides of a middle pivot connection (30), the first external threaded part (31) and the second external threaded part (32) respectively connected with the first internal threaded part (212) and the second internal threaded part (222) of the first embedding part (211) and the second embedding part (221) of the vise (2), two ends of the transmission shaft (3) being connecting ends (33), and
a supporting seat (4) having a lower part thereof connected to the zero point slot (14), an upper part of the supporting seat (4) connected to the middle pivot connection (30) of the transmission shaft (3) to support and position the transmission shaft (3), by using a hand tool (7) to connect to one of the connecting ends (33) of the transmission shaft (3), and rotating the transmission shaft (3), the vise (2) grips or releases a workpiece (5).

2. The center vise structure as claimed in claim 1, wherein the zero point slot (14) is a circular slot with two connecting through-holes (142) defined in an inner bottom thereof, a block body (42) extends upward from a circular part (41) of the supporting seat (4), the block body (42) has a receiving pivot hole (421) to support the middle pivot connection (30) of the transmission shaft (3), the circular part (41) has two connecting screw holes (411) located corresponding to the two connecting through-holes (142) of the base (1) so as to connect the supporting seat (4) to the zero point slot (14) by means of two screws (43).

3. The center vise structure as claimed in claim 2, wherein the middle pivot connection (30) of the transmission shaft (3) is a circular flange (301), two annular grooves (302, 303) are respectively defined in both sides of the circular flange (301) to provide installation for two O-rings (304, 305), a cover body (242) with a center through-hole (2421) is connected to the block body (42) of the supporting seat (4), to cover the receiving pivot hole (421) of the supporting seat (4) and the middle pivot connection (30) of the transmission shaft (3).

4. The center vise structure as claimed in claim 1, wherein the first embedding part (211) and the second embedding part (221) of the vise (2) are two individual component bodies, with several screws (23) combining the first embedding part (211) and the second embedding part (221) to the first movable jaw block (21) and the second movable jaw block (22), a protrusion (210) and a recess (2111) are respectively formed between the first embedding part (211) and the first movable jaw block (21), and between the second embedding part (221) and the second movable jaw block (22).

5. The center vise structure as claimed in claim 4, wherein a guide groove (111) and a guide block (2112) are respectively formed between two sides of the first embedding part (211) and the second embedding part (221) of the vise (2), and two sides of the receiving slot (11) of the base (1), the first external threaded part (212) and the second external threaded part (222) are both ACME thread.

6. The center vise structure as claimed in claim 1, wherein the first internal threaded part (212) and the second internal threaded part (222) of the vise (2) are two individual component bodies, with several screws (23) combining the first internal threaded part (212) and the second internal threaded part (222) respectively to a first socket hole (213) and a second socket hole (223) in the first embedding part (211) and the second embedding part (221).

7. The center vise structure as claimed in claim 6, wherein each of the first internal threaded part (212) and the second internal threaded part (222) includes a triangular head (2121, 2221) combined with a threaded tube sleeve (2122), each triangular head (2121, 2221) has three equally divided slots (2124, 2224) through which several screws (2223) extend, the first embedding part (211) and the second embedding part (221) have several screw holes (2113, 2213) located corresponding to the three equally divided slots (2124, 2224) thereof.

8. The center vise structure as claimed in claim 1, wherein two brush ring assemblies (24) are connected to inner edges of the first internal threaded part (212) and the second internal threaded part (222) of the vise (2), and the two brush ring assemblies (24) are each composed of a brush ring (241) and a cover body (242) with a center through-hole (2421).

9. The center vise structure as claimed in claim 1, wherein the base (1) has two side slots (15) formed to two sides thereof, two embedding slots (151) are formed on an inner end wall of the two side slots (15), a lower positioning slot (17), several positioning holes (19), and two limiting positioning pins (26) are located in a middle of the bottom of the base (1).

10. The center vise structure as claimed in claim 9, wherein the two upper fixing slots (152) are defined in a middle of the two side slots (15) of the base (1), a first scale (18) is formed on one of two sides of the base (1), a second scale (25) is formed on a top surface of the vise (2).
